(19) United States
(12) Patent Application Publication
(10) Pub. No.: US 2023/0294626 A1
(43) Pub. Date: Sep. 21, 2023

(54) Structural Component

(71) Applicant: Bayerische Motoren Werke Aktiengesellschaft, Muenchen (DE)

(72) Inventors: Majid HOJJAT, Muenchen (DE); Alexander KERSCHER, Markt Indersdorf (DE); Arne KOEHLER, Pliening (DE); Lin MOELLENHOFF, Odelzhausen (DE); Roland WANKA, Buch am Erlbach (DE)

(21) Appl. No.: 18/021,617

(22) PCT Filed: Aug. 20, 2021
(86) PCT No.: PCT/EP2021/073162

§ 371 Date: Feb. 16, 2023

(30) Foreign Application Priority Data
Sep. 22, 2020 (DE) 10 2020 124 654.4

(51) Int. Cl. B60R 19/48; B60R 19/03

(52) U.S. Cl. CPC B60R 19/48; B60R 19/03; B60R 13/00

(57) ABSTRACT

A structural component made of a plastics material for a skin of a body of a motor vehicle has a separating line that separates the structural component into an inner region and an outer region. The inner region has three-dimensional regions having reduced material thickness for defined pivotability with a reduced force requirement. The design means that a significantly lower force requirement is needed for opening or closing the inner region.

### BACKGROUND AND SUMMARY

The invention relates to a structural component and, in particular, to a structural component made of a plastic material for an outer skin of a motor vehicle.

Flat components can be readily bent when they are planar. In this instance, the bending direction can be freely selected. With once-curved faces, the bending direction is predetermined by the existing curvature. With twice-curved faces, a bending is also possible but this is linked with increased application of force.

Deformations lead to tensions in a component. These may be bending stresses or additional membrane tensions. In the case of a purely bending loading, the energy input into a system with comparable deformation amplitude is lower than with a combination of bending and membrane loading. A selective wall thickness reduction along a line is usual with plastics material components and is referred to as a film hinge. In this instance, a bending stress occurs exclusively in the region where the wall thickness is reduced. As a result of high material expansion, the remaining wall thickness of the film hinge must be very small. Without local wall thickness reduction, there is extensively a bending stress with a correspondingly small material expansion.

In principle, the more force that has to be applied in order to deform a component, the more energy the component must absorb. In this instance, in the context of a cyclical loading, it should be taken into account that the absorbed energy should be purely of the resilient type. Should a deformation be produced by means of an actuator, it is desirable to minimize the force required for the deformation. Costs and weight can thus be saved. In the same manner, the durability of the component to be deformed is improved.

In the industrial standard, there occur structural components which:
as a result of a linear wall thickness reduction permit a defined deformation;
having a defined region, which have a maximum of a single curvature and which without a local wall thickness reduction permit a defined deformation;
reinforce as a result of folded regions, for example, folding mechanisms with paper.

With regard to the general technical background, reference may be made, for example, to the German patent document DE 20 2018 103 730 U1. From this Utility Model specification a can with a snap-fit closure is known. A closure system having a three-dimensional structure which has an opening which is intended to be closed and a cover for placing on the three-dimensional structure in order to close the opening is proposed, wherein the cover has the following:
a front wall which can be deformed in a bistable manner between a first state curved in an insertion direction and a second state curved counter to the insertion direction, and
an annular edge portion which in the first bistable state has a larger outer circumference than in the second bistable state and is therefore configured to bring about a clamping securing of the cover to a wall region of the opening by the edge portion pressing in the first state internally or in the second state externally against the wall region,
wherein the three-dimensional structure is configured to direct a force which is applied at predefined locations from the outer side to the closure system in such a manner that it leads to a snap-over of the cover from one state into the other of the two bistable states.

Another defined deformation of a component is known from the German patent document DE 10 2011 001 690 A1. This document describes an internal trim for a vehicle having increased crash safety, having a deformable internal trim element which is arranged on a receiving element. At least below the internal trim element a hollow space is formed, wherein the internal trim element is constructed in such a manner that, in the event of an impact of an impact member, it at least partially protrudes into the hollow space. To this end, there is provision for there to be provided in the structure of the internal trim element in at least one region a material recess by means of which the deformation behavior of the internal trim element is influenced in such a manner that, when a force acts from an active direction on the internal trim element, at least one region of the internal trim element is deflected laterally with respect to the active direction of the force.

Furthermore, the European Patent Application EP 2 455 169 A1, inter alia, discloses a method for deforming a plate-shaped material into a three-dimensional object. In this instance, the plate-like material is shaped on a die by applying pressure at a side of the material facing away from the die. The method according to the invention is characterized in that in the plate-like material in regions thereof which are intended to be deformed prior to the deformation at the side facing away from the die a reduction of the material thickness is carried out. A method for deforming a plate-like material into a three-dimensional object is also proposed. The plate-like material is bent along one or more bending lines, wherein in the plate-like material in regions thereof which are intended to be deformed prior to the deformation a linear reduction of the material thickness is carried out and subsequently the material is manually bent over along this linear material thickness reduction.

With the exception of a few individual cases with very simple mechanisms, there are currently no industrial applications for surfaces with complex geometric shapes with defined regions (film hinges) in which the wall thickness is reduced in order by means of a mechanism (activation of different film hinges in a specific sequence) to permit a deformation with little resistance.

An object of the present invention is to set out a structural component which is made of a plastics material and which can be deformed with very little force which is intended to be applied.

This object is achieved according to the invention by the features in accordance with the independent claim. Advantageous developments of the invention are described in the dependent claims.

The present invention relates to structural components which have regions with a different wall thickness and which, as a result of local wall thickness reductions, have defined deformation possibilities. In particular, the region with reduced wall thicknesses do not constitute linear segments, but instead a free-form geometry which is ideally adapted to the surface geometry. The applications are versatile and can relate to products far beyond the automotive sector.

In the context of the development, for example, of bumper trims, there are attempts to provide openings depending on the operating state. Without a visible flap which is moved as an additional component on a hinge, there are possibilities for constituting a joint on a trim component and by means of an actuator deforming the component in such a manner that from the joint an opening, for example, an air inlet, is formed. The present invention advantageously enables surfaces to be constituted in accordance with design wishes which permit deformations with little actuator forces and which in the deformed state do not have any plastic expansions.

A configuration wherein the inner region can be reversibly pivoted by an actuator is particularly advantageous for the present invention since the actuator only has to apply small forces, which saves weight and costs.

A configuration wherein the reduced material thickness is between 10% and 90%, in particular between 10% and 60% of the whole material thickness of the structural component, is a particularly preferred material thickness range.

The fact that the inner region can be pivoted by the actuator between 0° and 100° with respect to the positionally fixed structural component enables the opening and closure of a flap which practically cannot be seen.

In a particularly preferred manner, the structural component is an injection-molded component or a deep-drawn component, wherein a thermoplastic plastics material is preferably used. In this instance, for example, this may be acrylonitrile-butadiene-styrene (ABS), polyamide (PA), polymethyl methacrylate (PMMA), polycarbonate (PC), polyethylene terephthalate (PET), polyethylene (PE), polypropylene (PP), polystyrene (PS), etcetera.

A configuration wherein the actuator is an electromechanical, hydraulic or pneumatic actuator are three preferred embodiments in which the actuator does not have to apply any significant force.

A configuration wherein the structural component is at least a portion of a bumper trim of the motor vehicle is, in addition to many other embodiments, a preferred embodiment.

A configuration wherein that the inner region is an air inlet is also a preferred variant with which, for example, cooling measures can be carried out.

A configuration wherein that the whole material thickness of the structural component is between 1 mm and 6 mm has been found to be particularly positive in test series.

The invention is explained in greater detail below with reference to the drawings.

### BRIEF DESCRIPTION OF THE DRAWINGS

FIG. 1 is a plan view of a motor vehicle according to an embodiment of the invention with a closed inner region.

FIG. 2 is a plan view of the motor vehicle according to the embodiment of the invention with an open inner region.

FIG. 3 shows a section through a front end of a motor vehicle with an exemplary structural component according to the invention.

FIG. 4a shows a first embodiment.

FIG. 4b shows a second embodiment.

FIG. 4c shows a third embodiment.

FIG. 5a shows a structural component according to the prior art.

FIG. 5b shows the structural component according to an embodiment of the invention.

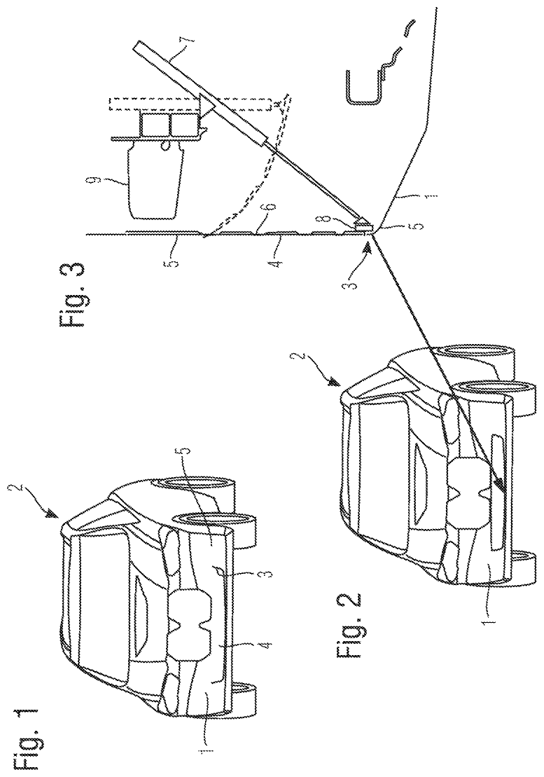

The same reference numerals are used below in FIGS. 1 to 5b for the same structural elements.

### DETAILED DESCRIPTION OF THE DRAWINGS

FIG. 1 shows a plan view of a motor vehicle 2. The motor vehicle 2 has a structural component 1 which, in the present embodiment, constitutes a bumper trim of the motor vehicle 2. The structural component 1 has a separation joint 3 which divides the structural component into an inner region 4 and an outer region 5. In FIG. 1, the inner region 4 is closed, this means that the structural component 1 appears as a single structural component 1 to an observer.

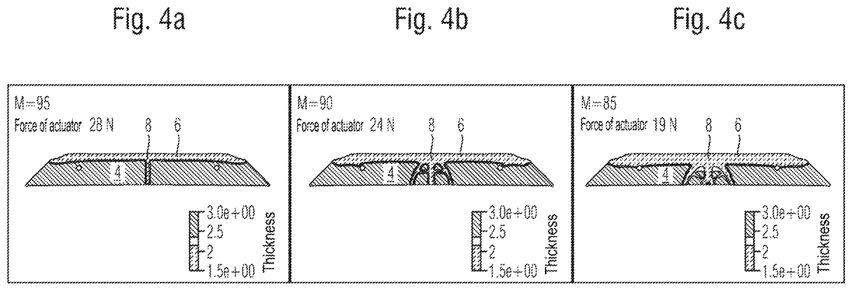

The structural component 1 is made of plastics material, in particular a thermoplastic plastics material as illustrated in the introduction, in this embodiment for an outer skin of a body of the motor vehicle 2. The inner region 4 and the adjacent outer region 5 have, for a defined pivotability of the inner region 4 with a reduced application of force, three-dimensional regions having a reduced material thickness 6. Three examples of this are illustrated in FIGS. 4a, 4b and 4c.

FIG. 2 shows the motor vehicle 2 from FIG. 1 again, but in this instance the inner region 4 is pivoted so that an air inlet in the bumper trim is thereby illustrated.

FIG. 3 shows a section through a front end of the motor vehicle 2 with the structural component 1. The inner region 4 which can be folded in is partially illustrated with a thinner wall thickness, the reduced material thickness 6, than the remainder of the structural component 1. An arrow which points from FIG. 3 to FIG. 2 shows an engagement location 8 for an actuator 7. The actuator 7 is, for example, pivotably supported in the region of an electrically actuatable motor 9. If the motor 9 is electrically controlled, the actuator 7 pulls the inner region 4 of the structural component 1 away inwardly and upwardly. The pivoted situation, as also illustrated in FIG. 2, is illustrated with broken lines in FIG. 3. It can be clearly seen how the actuator 7 is moved from an inclined position into a vertical position and in this instance via the actuator engagement location 8 folds the inner region 4 of the structural component 1 away inwardly and upwardly or opens it.

According to the invention, the structural component 1 has the separation joint 3 which separates the structural component 1 into the inner region 4 and the outer region 5, wherein the inner region 4 has, for a defined pivotability with a reduced application of force, three-dimensional regions having a reduced material thickness 6. The regions of the reduced material thickness 6 are illustrated in FIGS. 4a to 4c.

Preferably, the reduced material thickness 6 has between 10% and 90%, in particular between 10% and 60%, of the complete or maximum material thickness of the structural component 1. Furthermore, the inner region 4 can be pivoted by the actuator 7 between 0° and 100° with respect to the positionally fixed structural component 1.

Preferably, the structural component 1 is an injection-molded component or a deep-drawn component, wherein it is preferably produced from a thermoplastic plastics material.

Furthermore, the actuator 7 is preferably an electromechanical, hydraulic or pneumatic actuator, wherein for an electromechanical actuator, for example, a spindle drive can be provided.

In a particularly preferred manner, the structural component 1 is at least a portion of a bumper trim of the motor vehicle 2, as illustrated in the present embodiment. Furthermore, the inner region 4 is preferably an air inlet, as could be required for a temperature control of a unit which is arranged behind the structural component 1.

The structural component 1 preferably has a whole material thickness between 1 mm and 6 mm since the best results with respect to the deformation behavior have hereby been achieved in practical tests.

In FIGS. 4a to 4c, an inner region 4 of the structural component 1 is illustrated in each case, wherein the bottom edge from FIGS. 1 to 3 is illustrated in FIGS. 4a to 4c at the top (rotated through 180°). The regions of the reduced material thickness 6 are illustrated in each case in FIGS. 4a to 4c.

In this instance, in FIG. 4a M=95, the reduced material thickness 6 corresponds to 95% of the maximum wall thickness. In FIG. 4a, it can be seen that the actuator 7 with a material reduction of 5% has to apply a force of 28 N in order to pivot the inner region 4 of the structural component 1.

FIG. 4b again shows the same inner region 4 as FIG. 4a, but the reduced material thickness 6 is 90% of the maximum wall thickness. This results in a resultant force which has to be applied by the actuator 7 of 24 N, that is to say, less than in FIG. 4a.

FIG. 4c again shows the same inner region 4 as FIG. 4a and FIG. 4b, but the reduced material thickness 6 is now 85% of the maximum wall thickness.

This results in a resultant force which has to be applied by the actuator 7 of 19 N, that is to say, significantly less than in FIG. 4a.

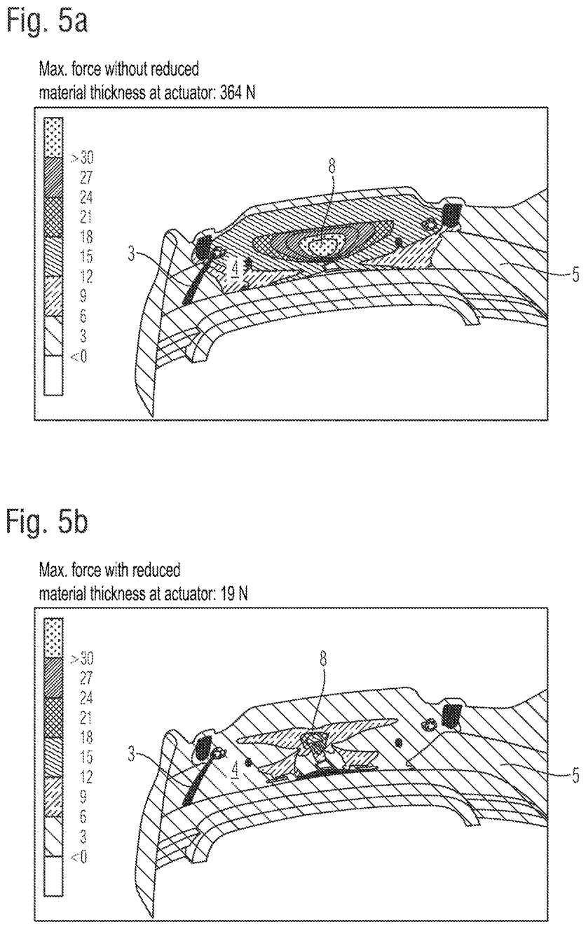

FIG. 5a shows a plan view of the structural component 1. The inner region of the structural component 1 is in turn designated 4 and the outer region is designated 5. The separation joint is again designated 3. The actuator engagement location 8 shows the engagement location of the actuator 7 again. The resulting force in the structural component 1 is illustrated in a state distributed over circles. In FIG. 5a, the entire structural component 1 has the maximum material thickness, resulting in a force which has to be applied by the actuator 7 of 364 N in order to pull up or pivot the inner region 4.

FIG. 5b shows the structural component 1 of FIG. 5a again, but with the reduced material thickness 6 according to the invention. It can be clearly seen that the actuator 7 now with a significantly reduced force of 19 N is in a position to pull up or to pivot the inner region 4.

The present invention consequently relates to a large number of structural components 1, which have regions with different wall thicknesses and which as a result of local wall thickness changes have defined deformation possibilities. In particular, the regions with a reduced wall thickness do not constitute linear elements, but instead a free-form geometry which is adapted to the surface geometry.

### LIST OF REFERENCE NUMERALS

1 Structural component
2 Motor vehicle
3 Separation joint
4 Inner region
5 Outer region
6 Reduced material thickness
7 Actuator
8 Actuator engagement location
9 Motor

1.-10. (canceled)

11. A structural component, comprising:
a plastic structural component configured for an outer skin of a body of a motor vehicle, wherein
the structural component has a separation joint which separates the structural component into an inner region and an outer region, and
the inner region includes three-dimensional regions having a reduced material thickness in order to provide a defined pivotability with a reduced application of force.

12. The structural component according to claim 11, further comprising:
an actuator by which the inner region is reversibly pivotable.

13. The structural component according to claim 11, wherein
the reduced material thickness is between 10% and 90% of an overall material thickness of the structural component.

14. The structural component according to claim 11, wherein
the reduced material thickness is between 10% and 60% of an overall material thickness of the structural component.

15. The structural component according to claim 12, wherein
the inner region is pivotable by the actuator between 0° and 100° with respect to a positionally fixed structural component.

16. The structural component according to claim 11, wherein
the structural component is an injection-molded component or a deep-drawn component.

17. The structural component according to claim 11, wherein
the structural component is a thermoplastic plastics material component.

18. The structural component according to claim 12, wherein
the actuator is an electromechanical, hydraulic or pneumatic actuator.

19. The structural component according to claim 11, wherein
the structural component is at least a portion of a bumper trim of the motor vehicle.

20. The structural component according to claim 11, wherein
the inner region is an air inlet.

21. The structural component according to claim 13, wherein
the overall material thickness of the structural component is between 1 mm and 6 mm.
